(19) United States
(12) Patent Application Publication
(10) Pub. No.: US 2023/0256917 A1
(43) Pub. Date: Aug. 17, 2023

(54) LIGHT-EMITTING EMBLEM

(71) Applicant: TOYODA GOSEI CO., LTD., Kiyosu-shi (JP)

(72) Inventor: Yoshihide NODA, Kiyosu-shi (JP)

(21) Appl. No.: 18/147,059

(22) Filed: Dec. 28, 2022

(30) Foreign Application Priority Data
Feb. 14, 2022 (JP) 2022-020284

(51) Int. Cl. B60R 13/00; F21S 43/31; F21S 43/20; F21S 43/14; F21S 43/50; B60Q 1/00

(52) U.S. Cl. CPC B60R 13/005; F21S 43/31; F21S 43/26; F21S 43/14; F21S 43/50; B60Q 1/0017

(57) ABSTRACT

A light-emitting emblem includes a light-emitting element, a reflector to reflect light emitted from the light-emitting element, a housing that houses the light-emitting element and the reflector, and a cover including an emblem on a surface thereof and a light-emitting portion on the surface to allow light emitted from the light-emitting element to be extracted therethrough, the cover being attached to the housing so as to cover the light-emitting element and the reflector. The light-emitting element is disposed such that an optical axis thereof is directed to the cover. The reflector includes two side walls facing each other with the light-emitting element positioned therebetween and extending from the housing side toward the cover, and an opening outlined by end portions of the two side walls on the cover side. Light emitted from the light-emitting element is reflected at an inner surface of the reflector and guided to the light-emitting portion.

### CROSS-REFERENCE TO RELATED APPLICATIONS

The present patent application claims the priority of Japanese patent application No. 2022/020284 filed on Feb. 14, 2022, and the entire contents of Japanese patent application No. 2022/020284 are hereby incorporated by reference.

### TECHNICAL FIELD

The present invention relates to a light-emitting emblem and, in particular, to a light-emitting emblem installed on a vehicle such as automobile.

### BACKGROUND ART

An emblem is known which is attached to a vehicle, etc., and can be illuminated (see Patent Literature 1). The emblem described in Patent Literature 1 is configured such that plural LEDs are housed in a component compartment formed between a lower cover and an upper cover and light emitted by the LEDs is transmitted and extracted through a side wall of the upper cover. Thereby, inner and outer edges of the emblem are illuminated.

### CITATION LIST

### Patent Literature

Patent Literature 1: JP 5546010 B2

### SUMMARY OF INVENTION

According to the structure of the emblem described in Patent Literature 1, light directly travelling from the LEDs as light sources toward the side wall of the upper cover as a light extraction portion is mainly extracted. Therefore, it is necessary to dispose a number of LEDs in a wide range in the emblem to provide high brightness and uniform light emission, which results in high manufacturing costs.

It is an object of the invention to provide a light-emitting emblem that can maintain high brightness and uniform light emission even when using a relatively small number of light sources.

An aspect of the invention provides a light-emitting emblem defined in (1) to (4) below.

(1) A light-emitting emblem, comprising:
a light-emitting element as a light source;
a reflector to reflect light emitted from the light-emitting element;
a housing that houses the light-emitting element and the reflector; and
a cover comprising an emblem on a surface thereof and a light-emitting portion on the surface to allow light emitted from the light-emitting element to be extracted therethrough, the cover being attached to the housing so as to cover the light-emitting element and the reflector;
wherein the light-emitting element is disposed such that an optical axis thereof is directed to the cover,
wherein the reflector comprises two side walls facing each other with the light-emitting element positioned therebetween and extending from the housing side toward the cover, and an opening outlined by end portions of the two side walls on the cover side, and
wherein light emitted from the light-emitting element is reflected at an inner surface of the reflector and guided to the light-emitting portion.

(2) The light-emitting emblem defined in (1), wherein the reflector is placed so that an upper edge thereof is separated from the cover.

(3) The light-emitting emblem defined in (1) or (2), wherein a minimum distance between the reflector and the cover in a thickness direction of the light-emitting emblem is not more than 10 mm.

(4) The light-emitting emblem defined in any one of (1) to (3), wherein the opening is located directly below the entire region of the light-emitting portion.

### Advantageous Effects of Invention

According to an embodiment of the invention, a light-emitting emblem can be provided that can maintain high brightness and uniform light emission even when using a relatively small number of light sources.

### BRIEF DESCRIPTION OF DRAWINGS

FIG. 1A is a front view showing a light-emitting emblem in an embodiment of the present invention.

FIG. 1B is a cross-sectional view showing the light-emitting emblem cut along line A-A shown in FIG. 1A.

FIG. 2A is a front view showing the light-emitting emblem when a cover is removed.

FIG. 2B is a partial cross-sectional view showing the light-emitting emblem cut along line B-B shown in FIG. 2A.

FIGS. 3A and 3B are perspective views showing a reflector when viewed from different angles.

### DESCRIPTION OF EMBODIMENTS

### (Configuration of a Light-Emitting Emblem)

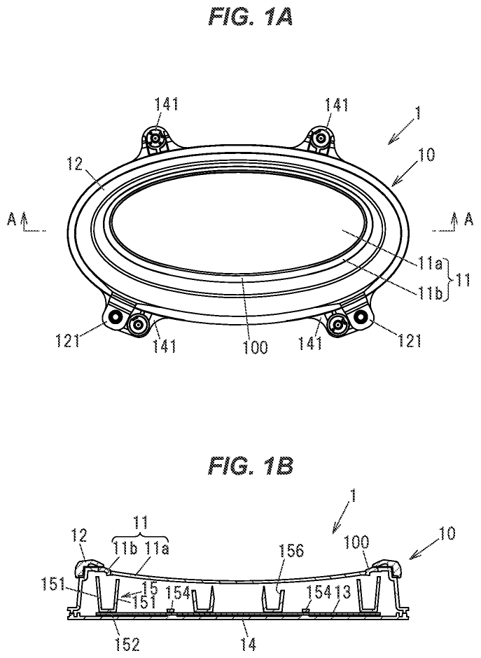

FIG. 1A is a front view showing a light-emitting emblem 1 in an embodiment of the invention. FIG. 1B is a cross-sectional view showing the light-emitting emblem 1 cut along line A-A shown in FIG. 1A.

The light-emitting emblem 1 includes light-emitting elements 131 as light sources, a reflector 15 to reflect light emitted from the light-emitting elements 131, a housing 14 that houses the light-emitting elements 131 and the reflector 15, and a cover 10 that includes, on a surface, a light-emitting portion 100 allowing light emitted from the light-emitting elements 131 to be extracted and is attached to the housing 14 so as to cover the light-emitting elements 131 and the reflector 15. Here, the light-emitting portion 100 of the cover 10 described above is an externally exposed portion of a light-transmitting portion 11b that constitutes a cover main body 11 described later.

The light-emitting elements 131 are placed so that optical axes thereof are directed to the cover 10. The reflector 15 has two side walls 151 facing each other with the light-emitting elements 131 positioned therebetween and extending from the housing 14 side toward the cover 10, and an opening 156 outlined by end portions of the two side walls 151 on the cover 10 side. In the light-emitting emblem 1, the light emitted from the light emitting elements 131 is reflected at an inner surface of the reflector 15, such as facing surfaces of the two side walls 151, and is guided to the light-emitting portion 100 of the cover 10.

The light-emitting element 131 is a light-emitting element mounted on a printed circuit board 13, and is typically an LED. The printed circuit board 13 is placed so that a surface on which the light-emitting elements 131 are mounted faces the cover 10. The printed circuit board 13 is fixed to the housing 14.

The housing 14 is formed of, e.g., ASA (acrylonitrile-styrene-acrylic ester). Since the light emitted from the light-emitting elements 131 is guided by the reflector 15 to the light-emitting portion 100 of the cover 10, light incident on the housing 14 is little. Therefore, the material of the housing 14 has a small effect on intensity of light extracted from the light-emitting emblem 1, hence, it is not necessary to narrow the range of choice of materials to increase the reflectance of the housing 14.

The housing 14 has fixing portions 141 to fix the housing 14 to an object to which the light-emitting emblem 1 is attached, such as a front grill of a vehicle. For example, by tightening screws through screw fastening holes provided on the fixing portions 141, the housing 14 can be fixed to the object to which the light-emitting emblem 1 is attached.

The cover 10 has the cover main body 11 having a non-light-transmitting portion 11a not transparent to the light emitted from the light-emitting elements 131 and the light-transmitting portion 11b transparent to the light emitted from the light-emitting elements 131, and an emblem 12 placed on a surface of the cover main body 11. The non-light-transmitting portion 11a and the light-transmitting portion 11b may be integrally molded as one piece or may be separate parts.

The non-light-transmitting portion 11a is formed of, e.g., a resin such as ASA. The non-light-transmitting portion 11a may be formed by, e.g., molding a resin colored into black, etc., or a paint or plating may be applied to the surface.

The light-transmitting portion 11b is formed of a resin transparent to the light emitted from the light-emitting elements 131, such as PMMA (methyl methacrylate) or PC (polycarbonate). To improve uniformity of extracted light, the light-transmitting portion 11b may include a diffusing material such as TiO₂ particles, or may have a lens cut portion on a surface on the light-emitting element 131 side.

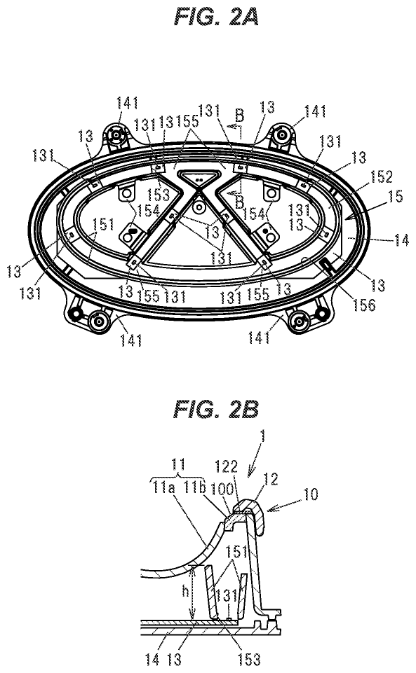

The emblem 12 is formed of, e.g., a resin such as ABS (acrylonitrile-butadiene-styrene) and its surface is plated. The emblem 12 has fixing portions 121 to fix the emblem 12 to the object to which the light-emitting emblem 1 is attached, such as a front grill of a vehicle. For example, by tightening screws through screw fastening holes provided on the fixing portions 121, the emblem 12 can be fixed to the object to which the light-emitting emblem 1 is attached. The emblem 12 may be also fixed to the cover main body 11by a double-sided tape 122, as shown in FIG. 2B.

As described above, a portion of the light-transmitting portion 11b is exposed to the outside and serves as the light-emitting portion 100. That is, the light emitted from the light-emitting elements 131 and captured by the light-transmitting portion 11b is extracted from the light-emitting portion 100 which is the exposed portion of the light-transmitting portion 11b. In the example shown in FIGS. 1A and 1B, the light-emitting portion 100 is provided along an inner contour of the emblem 12, and when the light-emitting elements 131 are turned on and lit, light is emitted along the inner contour of the emblem 12.

In this regard, although the emblem on the cover 10 is shown using the emblem 12 which is a dedicated component, the method for showing the emblem is not limited thereto. For example, a portion of the light-transmitting portion 11b as the light-emitting portion 100 or a portion of the non-light-transmitting portion 11a may be used to show the emblem. That is, the method for providing the emblem on the cover 10 is not limited.

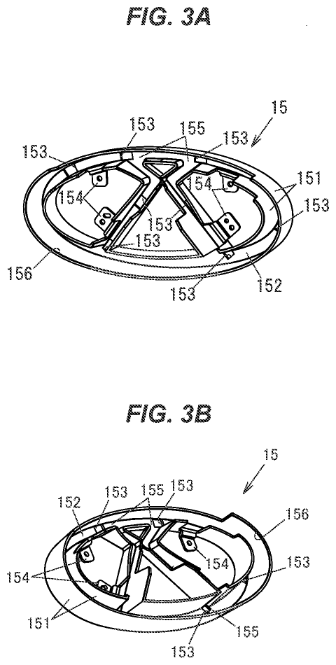

FIG. 2A is a front view showing the light-emitting emblem 1 when the cover 10 is removed. FIG. 2B is a partial cross-sectional view showing the light-emitting emblem 1 cut along line B-B shown in FIG. 2A. FIGS. 3A and 3B are perspective views showing the reflector 15 when viewed from different angles.

The reflector 15 has a bottom portion 152 arranged on the housing 14 side, and the two side walls 151 extending from both edges of the bottom portion 152. The two side walls 151 and the bottom portion 152 are usually molded as one piece. The bottom portion 152 has exposure holes 153 through which the light-emitting elements 131 mounted on the printed circuit board 13 are exposed to the cover 10 side. The two side walls 151 do not need to be perfectly parallel to a thickness direction of the light-emitting emblem 1, and may be inclined to some extent as shown in FIG. 2B, etc.

The reflector 15 is formed of a resin highly reflective to the light emitted from the light-emitting elements 131, such as PC (polycarbonate), ASA, ABS, AES (acrylonitrile-ethylene-propylene-diene-styrene), or PMMA, which is white. Particularly, the reflectance of the light emitted from the light-emitting elements 131 by the surface of the housing 14 is preferably not less than 85%. The reflector 15 is preferably formed by molding a white resin from the viewpoint of manufacturing cost, but may be formed of a non-white material of which surface is coated with a white paint.

In this regard, a highly reflective material such as aluminum may be deposited on the inner surface of the reflector 15, i.e., the facing surfaces of the two side walls 151 and an upper surface of the bottom portion 152, to improve the reflectance of the reflector 15. The inner surface of the reflector 15 may be embossed to improve diffusion of reflected light.

The reflector 15 has fixing portions 154 to fix the reflector 15 by screwing. For example, by passing screws through screw fastening holes provided on the fixing portions 154 and screw fastening holes provided on the printed circuit board 13 and tightening the screws into threaded holes provide on the housing 14, the printed circuit board 13 and the reflector 15 can be fixed to the housing 14.

The light emitted from the light-emitting elements 131 is guided directly, or indirectly by reflection at the inner surface of the reflector 15, to the light-transmitting portion 11b of the cover 10, enters the light-transmitting portion 11b, and is then extracted to the outside from the light-emitting portion 100 which is the exposed portion of the light-transmitting portion 11b. The light emitted diagonally upward from the light-emitting elements 131 is reflected at the inner surfaces of the side walls 151. Then, light reflected on the cover 10 side and returned to the light-emitting element 131 side is reflected at the inner surface of the reflector 15, i.e., at the facing surfaces of the two side walls 151 and the upper surface of the bottom portion 152, and is guided to the light-transmitting portion 11b again.

In the light-emitting emblem 1, the light emitted from the light-emitting elements 131 is efficiently guided by the reflector 15 to the light-transmitting portion 11b, i.e., to the light-emitting portion 100 of the cover 10, and is also effectively diffused by being repeatedly reflected at the inner surface of the reflector 15. Thus, even if the number of the light-emitting elements 131 used is relatively small, it is possible to maintain high brightness and uniform light emission, e.g., without continuously arranging a large number of light-emitting elements 131 directly below the light-emitting portion 100.

On the bottom portion 152 of the reflector 15, a surface of the printed circuit board 13 is exposed in the exposure holes 153 to the cover 10 side, and these exposed portions also serve as part of the light-reflecting surface. For this reason, the printed circuit board 13 is preferably a white circuit board formed using FR-4 or CEM3, etc., as a base material, or a circuit board formed such that portions of the surface to be exposed in the exposure holes 153 are painted white.

It is preferable that the opening 156 of the reflector 15 be located directly below the exposed portion of the light-transmitting portion 11b, i.e., the entire region of the light-emitting portion 100. This allows the light-emitting portion 100 to emit light more uniformly.

As shown in FIG. 2, the reflector 15 is preferably one continuous component provided for plural light-emitting elements 131, rather than being composed of plural components each provided for one light-emitting element 131. In particular, plural exposure holes 153 are provided, and light emitted from the plural light-emitting elements 131 exposed from the exposure holes 153 is reflected at the inner surface of the reflector 15 and is diffused. Diffusing the light emitted from the plural light-emitting elements 131 inside a single reflector 15 allows the light-emitting portion 100 to emit light more uniformly.

A space sandwiched between the two side walls 151 of the reflector 15 is preferably one continuous space without interruption, as shown in FIGS. 2 and 3. The light emitted from the light-emitting elements 131 is thereby more efficiently diffused inside the reflector 15, allowing the light-emitting portion 100 to emit light more uniformly.

In addition, the space sandwiched between the two side walls 151 of the reflector 15 preferably includes branched portions 155, as shown in FIGS. 2 and 3. By branching the space between the two side walls 151, the light path inside the reflector 15 can be increased and the light emitted from the light-emitting elements 131 can be more efficiently diffused inside the reflector 15. This allows the light-emitting portion 100 to emit light more uniformly.

In addition, the reflector 15 is preferably placed so that its upper edge, i.e., the upper edges of the side walls 151 are separated from the cover 10. In this case, even if the cover 10 receives an external force and bends, the impact is less likely to be transmitted to the reflector 15. As a result, misalignment of the reflector 15 or the light-emitting elements 131 and damage thereon can be suppressed and the light-emitting state of the light-emitting portion 100 can be maintained. In addition, to more effectively suppress misalignment of the reflector 15 or the light-emitting elements 131 and damage thereon, the minimum distance between the reflector 15 and the cover 10 in the thickness direction of the light-emitting emblem 1 is preferably not less than 2 mm.

To more efficiently guide the light emitted from the light-emitting elements 131 by the reflector 15 to the light-emitting portion 100, the upper edge of the reflector 15, i.e., the upper edges of the side walls 151 are preferably as close to the cover 10 as possible, and the minimum distance between the reflector 15 and the cover 10 in the thickness direction of the light-emitting emblem 1 is preferably, e.g., not more than 10 mm. A height h described hereinafter is a length in the thickness direction of the light-emitting emblem 1.

In addition, the greater the height h of the reflector 15, the higher the intensity of light extracted from the light-emitting portion 100. Therefore, the intensity of the light extracted from the light-emitting portion 100 can be adjusted by the height h of the reflector 15.

In addition, the higher the reflectance of the reflector 15, the higher the intensity of the light extracted from the light-emitting portion 100. Therefore, the intensity of the light extracted from the light-emitting portion 100 can be adjusted by the material of the reflector 15. For example, according to desired emission intensity, a polycarbonate with an appropriate reflectance can be selected from plural types of polycarbonates with different reflectance.

### (Effects of the Embodiment)

In the light-emitting emblem 1 in the embodiment of the invention, since the light emitted from the light-emitting elements 131 is efficiently guided by the reflector 15 to the light-emitting portion 100, it is possible to maintain high brightness and uniform light emission even when the number of the light-emitting elements 131 used is relatively small. Thus, for example, it is possible to suppress the number of the mounted light-emitting elements 131 and thereby to reduce the manufacturing costs while maintaining high brightness and uniform light emission.

Although the embodiment of the invention has been described, the invention is not limited to the embodiment described above and the various kinds of modifications can be implemented without departing from the gist of the invention. In addition, the constituent elements in the embodiment can be arbitrarily combined without departing from the gist of the invention.

In addition, the embodiment described above does not limit the invention according to claims. Further, please note that not all combinations of the features described in the embodiment are necessary to solve the problem of the invention.

### REFERENCE SIGNS LIST

1 LIGHT-EMITTING EMBLEM
10 COVER
100 LIGHT-EMITTING PORTION
11 COVER MAIN BODY
11a NON-LIGHT-TRANSMITTING PORTION
11b LIGHT-TRANSMITTING PORTION
12 EMBLEM
13 PRINTED CIRCUIT BOARD
131 LIGHT-EMITTING ELEMENT
14 HOUSING
15 REFLECTOR
151 SIDE WALL
156 OPENING

1. A light-emitting emblem, comprising:
a light-emitting element as a light source;
a reflector to reflect light emitted from the light-emitting element;
a housing that houses the light-emitting element and the reflector; and
a cover comprising an emblem on a surface thereof and a light-emitting portion on the surface to allow light emitted from the light-emitting element to be extracted therethrough, the cover being attached to the housing so as to cover the light-emitting element and the reflector;
wherein the light-emitting element is disposed such that an optical axis thereof is directed to the cover,
wherein the reflector comprises two side walls facing each other with the light-emitting element positioned therebetween and extending from the housing side toward the cover, and an opening outlined by end portions of the two side walls on the cover side, and
wherein light emitted from the light-emitting element is reflected at an inner surface of the reflector and guided to the light-emitting portion.

2. The light-emitting emblem according to claim 1, wherein the reflector is placed so that an upper edge thereof is separated from the cover.

3. The light-emitting emblem according to claim 1, wherein a minimum distance between the reflector and the cover in a thickness direction of the light-emitting emblem is not more than 10 mm.

4. The light-emitting emblem according to claim 1, wherein the opening is located directly below the entire region of the light-emitting portion.
